(19) United States
(12) Patent Application Publication
(10) Pub. No.: US 2009/0101862 A1
(43) Pub. Date: Apr. 23, 2009

(54) WATER SOLUBLE FOAM FIRE EXTINGUISHING COMPOSITE MATERIAL

(76) Inventor: Frank Hu, Taipei Hisen (TW)

Correspondence Address: FRANK HU, 235 Chung - Ho Box 8-24, Taipei, TW

(21) Appl. No.: 11/875,969

(22) Filed: Oct. 22, 2007

(51) Int. Cl. A62D 1/02

(52) U.S. Cl. 252/3

(57) ABSTRACT

A type of water soluble foam fire extinguishing composite material includes a foaming agent, sodium dodecyl benzene sulphonate (DBN), and water. Said sodium dodecyl benzene sulphonate (DBN) is a replacement for halogenated hydrocarbons, and exerts an extremely great effect on cooling and control of the intensity of a fire; because it has almost no effect on ozone in the stratosphere, it will not worsen global warming.

### BACKGROUND OF THE INVENTION

The present invention relates to a type of water soluble foam fire extinguishing composite material, which is a composite material with high fire extinguishing performance and environmental safety, and no toxic to the human body. Said composite material has almost no effect on the decomposition of the ozone layer, and has virtually no tendency to worsen the well-known phenomenon of greenhouse heating. In contrast, the composite material has extremely good fire extinguishing performance and ability to control the intensity of a fire. It is not toxic to the human body (and will not cause corrosion injuries), is not strongly corrosive, and will not cause the aftereffects of water fire extinguishing (such as severe water damage).

While the global economy is growing rapidly and the world population is swelling, usable land is increasing scarce. Continuous growth appears set to continue well into the future. Many countries are striving to gain more living space within their limited territories, and Taiwan is no exception to this trend. But since skyscrapers and high-rises are springing up throughout Taiwan in order to make the most of Taiwan's limited land area, high-rise safety has become increasingly important. In particular, protection against fire and fast means of fire extinguishing are vital to maintaining safe high-rise buildings. But because most people do not know how to prevent and extinguish fires, and because most ordinary homes have their own specific fire extinguishing methods, people inevitably become panicky and don't know what to do when a fire occurs. People thus often fail to use fire extinguishers in a speedy and effective manner even when they are available. And as a result, if a fire is allowed to grow too large, it may already be too late by the time fire extinguishers are used.

Two Important Factors Must be Kept in Mind When Extinguishing a Fire:

(1) Combustible materials must be kept away from air. (2) The high temperatures needed for ignition must be avoided or reduced. Because of this, people can put out small fires by covering the combustible materials with a blanket or layer of foam and thereby keeping them away from oxygen in the air. The customary response of pouring water on burning material to put out the fire works by reducing the temperature to a point where combustion cannot occur, and it can be very effective. In addition, water -can also smother a fire or separate the burning materials from the air. And because water is readily available in most ordinary homes, the first thing that appears in people's minds when a fire occurs is to use water to put the fire out. But although spraying water on a fire can put it out, the use of water in fire extinguishing can damage the structure of the building and articles in it. People often forget this fact. Nalogenated hydrocarbon fire extinguishing agents were introduced starting in the 1980's in an effort to alleviate the damage caused by the use of water in fire extinguishers. Halogenated hydrocarbon fire extinguishing agents can not only effectively put out fire, but also cause only minimal damage to buildings and objects in them.

At present the most commonly used halogenated hydrocarbon fire extinguishing agents are the brominated carbon compounds Halon 1301 (CF₃Br) and Halon 1211 (CF₂ClBr). It is generally accepted that these brominated fire extinguishing agents are extremely effective at extinguishing fires that are still in the early stages of growth. These fire extinguishing agents work by decomposing in the elevated temperature of a fire and generating bromine-containing products, which can block the self-sustaining combustion of free radicals. Brominated halogenated hydrocarbon fire extinguishing agents are therefore commonly used in tank-type fire extinguishers and automatic indoor spray systems triggered by fire detectors.

As has been explained, the public is aware that brominated halogenated hydrocarbon such as Halon 1211 can stop the process of combustion. But because these fire extinguishing agents contain bromine, they are very costly and toxic to humans. Because they may irritate the heart even at low concentrations, bromine-containing substances are not suitable for long-term use.

The use of brominated hydrocarbon fire extinguishing agents has encountered strong opposition in recent years because of their ability to destroy ozone in the earth's stratosphere. In particular, the role of chlorofluorocarbons (CFCs) in damaging the ozone layer has inspired great interest in the development of alternative cooling agents, solvents, and foaming agents. The public currently feels that brominated hydrocarbons such as Halon 1301 and Halon 1211 are as harmful to the ozone layer as CFCs, and their extreme stability also enables them to play a role in the further environmental problem of greenhouse warming.

As a consequence, in view of the foregoing disadvantages of halogenated hydrocarbon fire extinguishing agents and the fact that most people responding directly to the outbreak of fire try to put it out using readily-available water, the inventors have developed and extensively tested the composite material comprising this invention.

### SUMMARY OF THE INVENTION

The chief goal of this invention is to provide a fire extinguishing composite material, and specifically to provide a low-cost water soluble foam fire extinguishing composite material comprising a foaming agent, sodium dodecyl benzene sulphonate (DBN), and water that is not toxic to the human body or the environment.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

The present invention is based on the discovery that the use of effective amounts of a composite material comprising a foaming agent, sodium dodecyl benzene sulphonate (DBN), and water can prevent or effectively extinguish the combustion of combustible matter. Especially when used in enclosed spaces, this composite material will not cause the decomposition of ozone in the stratosphere or worsen the so-called greenhouse effect. The composite material contains 0.5 g EMAL—a foaming agent familiar to the public—and 1.5 g of sodium dodecyl benzene sulphonate (DBN) per kilogram of water. One kilogram of the composite material can be dissolved in 500 kg of water, and can generate a fine foam at a rate of 100 mm²/sec. after mixing and stirring.

Apart from being harmful to people and the environment, ordinary fire extinguishers are also costly to manufacture and are sold for high prices. While small fire extinguishers are often inadequate, large fire extinguishers are bulky, awkward to hold and use, take up a lot of space, and must be used according to specific procedures. As a result, at present ordinary homes and offices are by no means universally equipped with these fire extinguishers, and water sprinklers are still the most widely accepted and used fire extinguishing method. And since most premises are equipped with fire hydrants, obtaining water is very easy and convenient. Although the use of water to extinguish a fire will cause the aforementioned problem of water damage, water is still the most commonly used method of fighting small fires in enclosed spaces such as ordinary homes and offices. Water also has the advantages of low cost and good effectiveness. In view of these considerations, when a fire occurs in an enclosed space, people can pour the composite material comprising this invention directly into a pond or water tank, so that it will cut off the combustible matter from the air. And since the composite material is almost completely harmless to people and the environment, it can also be used by hand to put out a source of fire. The composite material can be kept in a disposable plastic bottle in most circumstances. This solution is inexpensive, convenient, and allows easy storage. One liter of this composite material can be added to 500 liters of water to replace the foregoing halogenated hydrocarbons; in use it will quickly lower the temperature below the combustion point and cut off the fire's air supply.

In order to prevent a fire from becoming established in an enclosed space, the amount of gas or gases used must be sufficient to reduce the total amount of oxygen per mole in that space so as to inhibit or prevent the combustion of matter capable of sustaining fire and not spontaneously combustible.

Depending on the particular types of combustible matter present in an enclosed space, different amounts of fire extinguishing material will be needed to suppress combustion. As is commonly known, while the combustibility of a material, which is its ability to ignite and sustain combustion under known environmental conditions, will vary depending on chemical and physics characteristics such as ratio of surface area to volume, thermal capacity, porosity, and other similar factors. For instance, thin and porous sheets of tissue paper will burn more easily than solid objects.

Generally speaking, a thermal capacity of approximately 40 cal/° C. and normal oxygen per mole is sufficient to prevent or suppress combustion of most relatively combustible materials such as wood and plastic. Thermal capacity exceeding the minimum requirement should ideally be provided in the case of certain highly-combustible materials so as to achieve an extra safety margin. A minimum oxygen per mole thermal capacity of 45 cal/° C. is adequate to inhibit the burning of moderately combustible materials. The foaming agent, sodium dodecyl benzene sulphonate (DBN), and water in this composite material are able to achieve this value.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A water soluble foam fire extinguishing composite material consisting of at least 0.5 g foaming agent and 1.5 g sodium dodecyl benzene sulphonate (DBN) in 1 liter of water.
